(19) United States
(12) Patent Application Publication
(10) Pub. No.: US 2016/0121455 A1
(43) Pub. Date: May 5, 2016

(54) POWER TOOL DUST PORT CONNECTOR MECHANISM

(71) Applicant: BLACK & DECKER INC., Newark, DE (US)

(72) Inventors: Philip T. MILLER, Phoenix, MD (US); Ethan L. HELMER, Nottingham, MD (US); Thomas F. DOEHNER, Timonium, MD (US); Adam PAST, York, PA (US)

(21) Appl. No.: 14/925,595

(22) Filed: Oct. 28, 2015

Related U.S. Application Data
(60) Provisional application No. 62/073,056, filed on Oct. 31, 2014.

(51) Int. Cl. B24B 55/10; F16B 7/04; B25F 5/02

(52) U.S. Cl. CPC B24B 55/10; B25F 5/02; F16B 7/042

(57) ABSTRACT

A connector mechanism that connects a dust bag or other accessory to a power tool. The connector mechanism including a collar assembly having proximal and distal ends, the proximal end engaging the power tool and the distal end comprising a plurality of castellations radially spaced about an interior surface thereof for non-selectively engaging a plurality of castellations on the power tool to establish a mating interface between the collar assembly and the dust port; and a plurality of locking members radially spaced about the collar assembly to establish a locking relationship between the collar assembly and the dust port.

### CROSS-REFERENCE TO RELATED APPLICATIONS

This application claims priority to U.S. provisional patent application Ser. No. 62/073,056 filed Oct. 31, 2014. The entirety of this application is incorporated herein by reference.

### BACKGROUND OF THE INVENTION

1. Field of the Invention

The present invention relates, in general, to the field of power tools. In particular, the present invention relates to a power tool for sanding a workpiece.

2. Description of the Related Art

The statements in this section merely provide background information related to the present disclosure and may not constitute prior art.

Orbital sanders are used in a wide variety of applications such as woodworking and auto body repair work. Such sanders typically employ a housing, a motor disposed within the housing, a shaft operably coupled to the motor, a shroud coupled to the housing for supporting and communicating with a dust collecting receptacle (attached hereto), and a fan operably coupled to the motor shaft for drawing a cooling air flow in through openings in the housing and exhausting the cooling air flow through openings in the shroud to help cool the motor. The shroud is preferably rotatably coupled to the housing to enable the dust collecting receptacle thereof to be rotated out of the way by the user to enable convenient use of the sander.

Random orbital sanders are one type of sander that typically includes a platen that is driven rotationally by a motor-driven spindle. The platen is driven via a freely rotatable bearing that is eccentrically mounted on the end of the drive spindle. Rotation of the drive spindle causes the platen to orbit about the drive spindle while frictional forces within the bearing, as well as varying frictional loads on the sanding disc attached to the platen, cause the platen to also rotate about the eccentric bearing, thereby imparting the “random” orbital movement to the platen. The fan, which is driven by the output shaft of the motor, is adapted to draw dust and debris generated by the sanding action up through openings formed in the platen and into the dust collecting receptacle.

Electric quarter sheet sanders are another type of orbital sander having an electric motor that drives an orbit mechanism that moves the platen in an orbital pattern. A sheet of sandpaper is removably fastened to the platen. When the platen with the sandpaper fastened thereto is applied to a work surface, such as to wood, the orbital motion of the platen moves the sandpaper in an orbital motion against the work surface to sand it. Since a full sheet of sandpaper is 9 inches by 11 inches and the sheet of sandpaper fastened to the platen is 4-½ inches by 5-½ inches, or ¼ of a full sheet of sandpaper, sanders of this type are commonly known as ¼ sheet sanders.

One issue that these sanders and dust generating power tools have in common is that although the dust bag is attached to the dust port of the tool, the dust bag is not locked to the tool and can be pulled away along the dust port axis.

In sanders with dust collectors, particularly those that use passive systems such as a cloth bag to catch dust, maintaining the dust collection apparatus in the locked position can be challenging. In an improvement to such passive systems, the present application discloses a power tool dust collection system that can be attachably locked to the housing dust port with a dust port connector mechanism.

### SUMMARY OF THE INVENTION

An embodiment of the invention is directed to a connector mechanism that connects a dust bag or other accessory to a power tool. The power tool can be a sander having a housing and a channel or dust port for exhausting dust generated during use. The connector mechanism includes a dust port on the tool housing having castellations on an exterior surface thereof that mate with castellations arranged on the interior surface of a collar assembly. The interlocking or mating castellations keep any accessory attached to the collar assembly, such as a dust bag from rotating when a user activates a locking member by rotating the collar assembly.

The number of castellations on the collar assembly can be less than the number of castellations of the dust port to help achieve a quick connection, specifically, a connection that does not require pre-alignment of the castellations. In this manner, any alignment of the dust port of the housing to the collar assembly creates an interface that can be locked with one fluid hand movement.

In an embodiment of the present invention, a power tool may include a housing; a dust port integrally formed with the housing; a first plurality of castellations radially spaced about the dust port at a distal end, wherein a proximal end of the dust port further includes an elongated portion adjacent to and axially spaced from the first plurality of castellations, the elongated portion having a continuous generally tubular shape; a collar assembly having proximal and distal ends, the proximal end engaging the elongated portion of the dust port and the distal end including a second plurality of castellations radially spaced about an interior surface thereof for non-selectively engaging the first plurality of castellations to establish a mating interface between the collar assembly and the dust port; and a plurality of locking members radially spaced about the collar assembly to establish a non-axially moveable locking relationship between the collar assembly and the dust port.

In another embodiment of the present invention, the power tool may include a collar assembly having an inner collar that is removably fixed to the dust port and an outer collar rotatable with respect to the inner collar.

In another embodiment of the present invention, the first plurality of castellations is integrally formed on an exterior surface of the dust port and the second plurality of castellations is integrally formed on an interior surface of the inner collar.

In another embodiment of the present invention, any of the second plurality of castellations on the inner collar achieve a mating interface with any of the first plurality of castellations on the dust port without pre-alignment, and the locking relationship between the collar assembly and the dust port creates a non-axially moveable connection between the collar assembly and the dust port.

In another embodiment of the present invention, the number of castellations on the inner collar can be greater than the number of castellations on the dust port.

In another embodiment of the present invention, the inner collar includes a plurality of apertures radially spaced thereabout and corresponding recess members on an exterior surface thereof, wherein the recess members are located between the plurality of apertures and the proximal end of the collar assembly, and the plurality of locking members float within the plurality of apertures in the inner collar.

In another embodiment of the present invention, the elongated portion of the dust port includes a radially configured locking member groove on an exterior surface thereof that receives the plurality of locking members.

In another embodiment of the present invention, the interior surface of the outer collar includes ramps having a rise portion and a tapered portion, wherein when the outer collar rotates in a first direction, the rise portion of the ramps apply a force against the locking members to press the plurality of locking members into the locking member groove in a friction fit to lock the collar assembly to the dust port and, when the outer collar rotates in a second direction, opposite to the first direction, the force applied by the ramps is removed to unlock the collar assembly from the dust port.

In a further embodiment of the present invention, a connector mechanism for a power tool includes a collar assembly having an inner collar and an outer collar disposed around the inner collar, and a plurality of locking members radially spaced about the inner collar between the inner collar and the outer collar. The plurality of locking members protrudes into the interior of the inner collar. The inner collar includes a plurality of castellations radially spaced about an interior surface thereof for non-selectively engaging a portion of the power tool, and the plurality of locking members exerts a force on said portion of the power tool to establish a locking relationship between the collar assembly and the power tool.

### BRIEF DESCRIPTION OF THE DRAWINGS

The numerous advantages of the present invention may be better understood by those skilled in the art by reference to the accompanying Figures. In the drawings, like reference numerals designate corresponding parts throughout the several views.

FIG. 1 illustrates a perspective view of an orbital sander according to an embodiment of the invention;

FIG. 2 illustrates a cross-sectional view of the orbital sander of FIG. 1 according to an embodiment of the invention.

FIG. 3 illustrates a perspective view of the connector mechanism and dust port according to an embodiment of the invention;

FIG. 4 illustrates an exploded view of the dust collection system according to an embodiment of the invention;

FIG. 5 illustrates a perspective view of the inner collar according to an embodiment of the invention; and

FIG. 6 illustrates a cross-sectional view of the connector mechanism according to an embodiment of the invention.

### DETAILED DESCRIPTION OF THE INVENTION

Reference will now be made in detail to the presently preferred embodiments of the invention, examples of which are illustrated in the accompanying drawings.

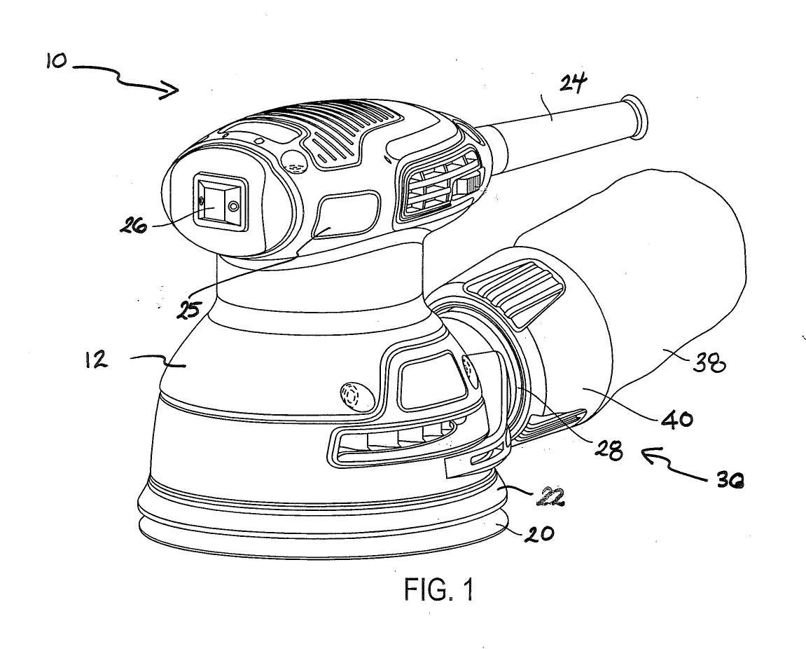

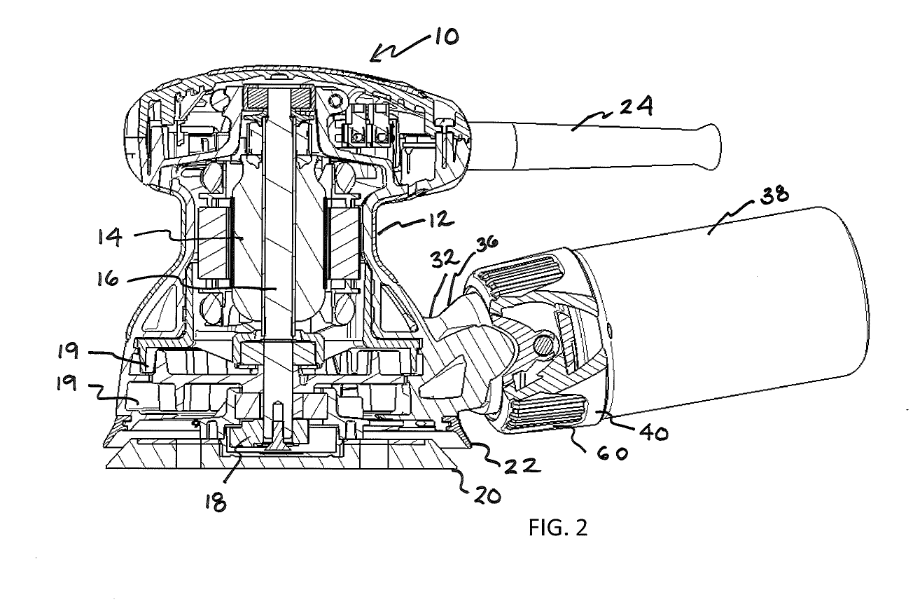

Turning to the FIGS. 1 and 2, an orbital sander is illustrated and designated with the reference numeral 10. The orbital sander includes a housing 12, a motor 14 disposed within the housing, an output shaft 16 driven by the motor, an orbital mechanism disposed beneath the housing, and a sanding element 20 coupled with the output shaft.

The orbital mechanism includes a platen 22 to which the sanding element 20 or other abrasives or materials (e.g., polishing pads) can be releasably adhered. Such sanding elements 20 can be configured in the pressure sensitive adhesive (PSA) variety as well as a hook and loop variety, each of which is familiar to those skilled in the art, and can be provided with holes to facilitate dust collection.

The platen 22 is adapted to be driven rotationally and in a orbital pattern by the motor 14. An AC power cord 24 is coupled with the housing 12 to provide power to the motor 14. The motor 14 is turned on and off by a suitable ON/OFF switch 26 coupled with the housing 12. Also, a plurality of textured members 25 for maintaining gripping control of the tool is on the exterior surface the housing 12.

In the orbital sander shown in FIGS. 1 and 2, the housing 12 is sized for a palm grip at the top of the housing and for a single-handed grip around the body. For a random orbital sander of the type shown in FIG. 1, output shaft 16 is typically directly coupled to a counterweight 18, which may incorporate integral fan blades 19 used for dust collection.

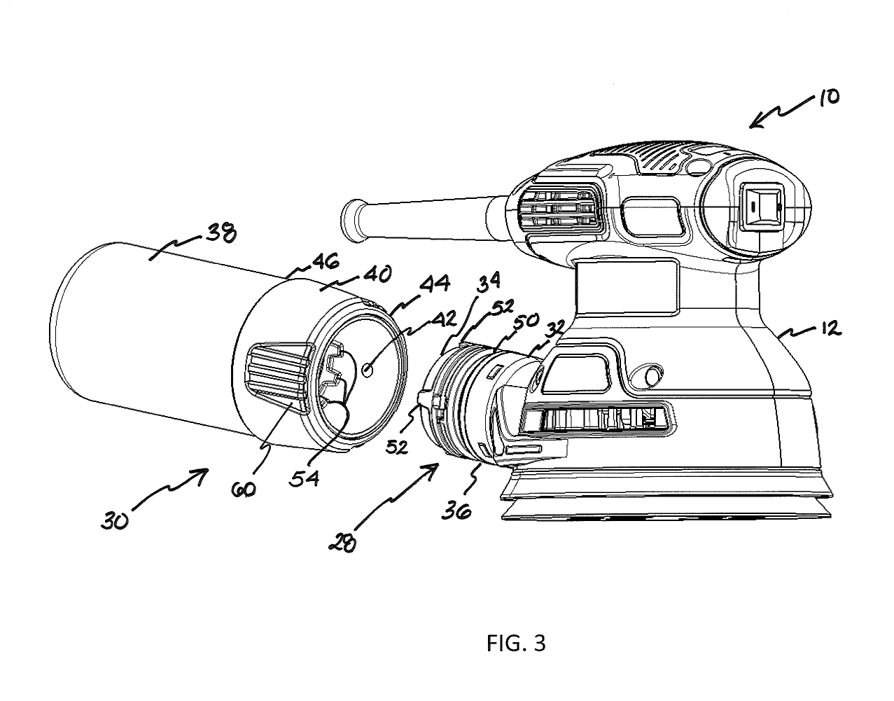

As illustrated in FIG. 3, the housing 12 includes a channel member or dust port 28 that exhausts dust generated by the frictional contact of the sanding element 20 with a workpiece, out of the housing. In an embodiment, the dust port 28 can be an integral portion of the tool housing 12. In another embodiment, the dust port 28 can be separately attachable to the tool housing 12. Dust collection is achieved through the dust collection system 30.

The dust port has a proximal end 32 connected to the housing 12 and a distal end 34 for exhausting dust. The interior of the dust port 28 includes a nozzle 27 for channeling the dust from the housing to the dust port. The proximal end 32 of the dust port 28 further includes an elongated portion 36 that is adjacent to and axially spaced from the distal end 34. The elongated portion 36 has a continuous generally tubular shape. The distal end 34 of the dust port includes a plurality of dust port castellations 52 on the exterior surface. In an embodiment, the dust port castellations 52 are radially spaced thereabout and form a raised surface.

The dust collection system 30 is coupled to the housing dust port 28. The dust collection system 30 includes a dust collecting receptacle, such as dust bag 38 for collecting debris from the power tool. The dust bag 38 may illustratively be removably secured to housing 12. The dust collection system 30 also includes a connector mechanism for connecting the dust bag 38 to the dust port 28.

The dust bag 38 can be formed by molding, sintering or by other means a rigid, porous, plastic material, preferably porous polyethylene, polypropylene, polystyrene, or other polyolefins having a pore size effective to retain sanding dust; it has been found that a pore size of 120-140 microns is satisfactory. In the embodiment shown, dust bag 38 is substantially cylindrical and has an internal diameter of approximately two inches, a length of approximately four inches, and a typical wall thickness of 0.15 inch. Those skilled in the art will recognize that other sizes and shapes of sander filters consistent with the present filter invention may also be useful.

FIGS. 3, 4 and 6 illustrate the connector mechanism that connects the dust bag 38 or other accessory to the power tool. As shown in FIGS. 3, 4 and 6, the connector mechanism can be in the form of a collar assembly 40 that is arranged to be operatively connected to the dust port 28. The collar assembly 40 is attachable to the elongated portion 36 or body of the dust port 28. For example, the collar assembly 40 can be attached around the body of the dust port 28. The dust bag 38 is connected to the collar assembly 40 by an attaching mechanism as known in the art.

The collar assembly 40 has a proximal end 44 and a distal end 46. The proximal end 44 engages the elongated portion 36 of the dust port 28. The distal end 46 of the collar assembly 40 is attached to the dust bag 38. The distal end 46 of the collar assembly also includes a plurality of castellations 54 radially spaced about an interior surface thereof for non-selectively engaging the plurality of dust port castellations 52 to establish a mating interface between the collar assembly 40 and the dust port 28.

The collar assembly 40 includes an inner collar 40a, an outer collar 40b, rotatable with respect to the inner collar, and at least one locking member 42 disposed therebetween. The inner collar castellations 54 are located on the inner collar 40a of the collar assembly 40 such that the inner collar can be operatively connected in a fixed relationship with the dust port 28 through the mating relationship of the respective castellations 52, 54. The outer collar 40b can be rotatably connected to the inner collar. The dust bag 38 is illustrated as fixed to the inner collar 40a at the distal end 46 of the collar assembly 40.

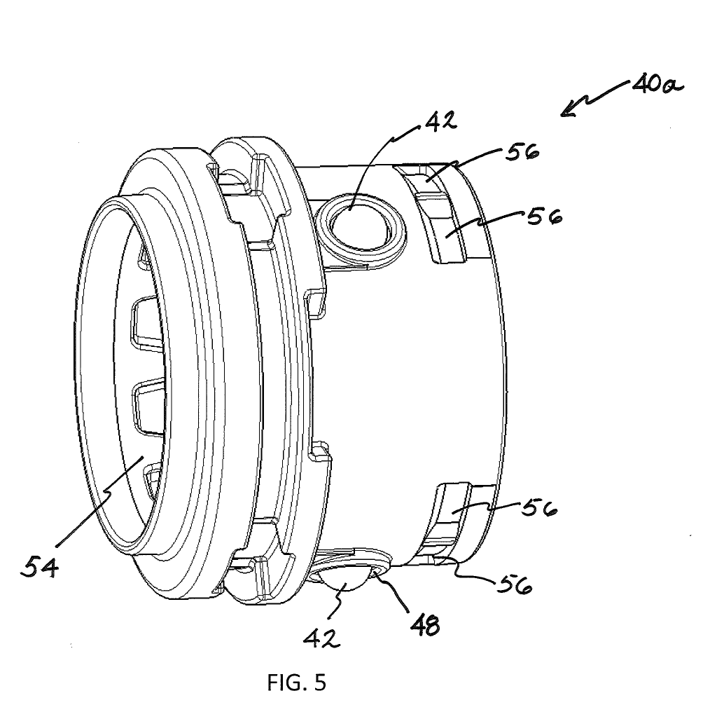

As shown in FIGS. 3-6, and in particular FIG. 5, a plurality of locking members 42 is radially spaced about the collar assembly 40 to establish a locking relationship between the collar assembly and the dust port 28. The locking relationship creates a non-axially moveable connection between the collar assembly 40 and the dust port 28.

The locking members 42 can be recessed within one or more locking member apertures 48 within the inner collar 40a. Specifically, the locking members 42 can be configured to float within the locking member apertures 48 and protrude into the interior of the inner collar.

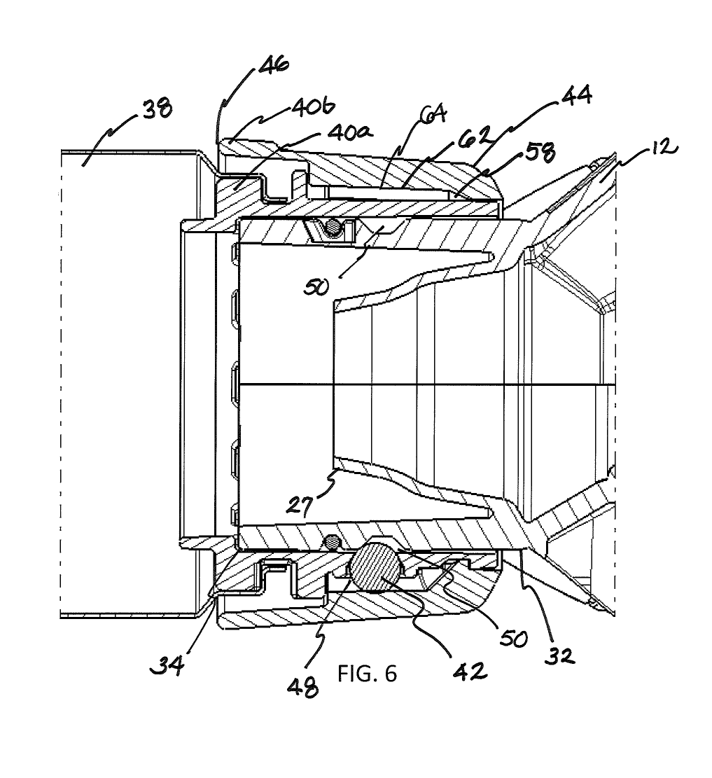

The elongated portion 36 of the dust port 28 includes a radially configured locking member groove 50, as shown in FIG. 6, on the exterior surface thereof. The locking member groove 50 receives the locking members 42 in a friction fit to effect locking of the collar assembly 40 to the dust port 28.

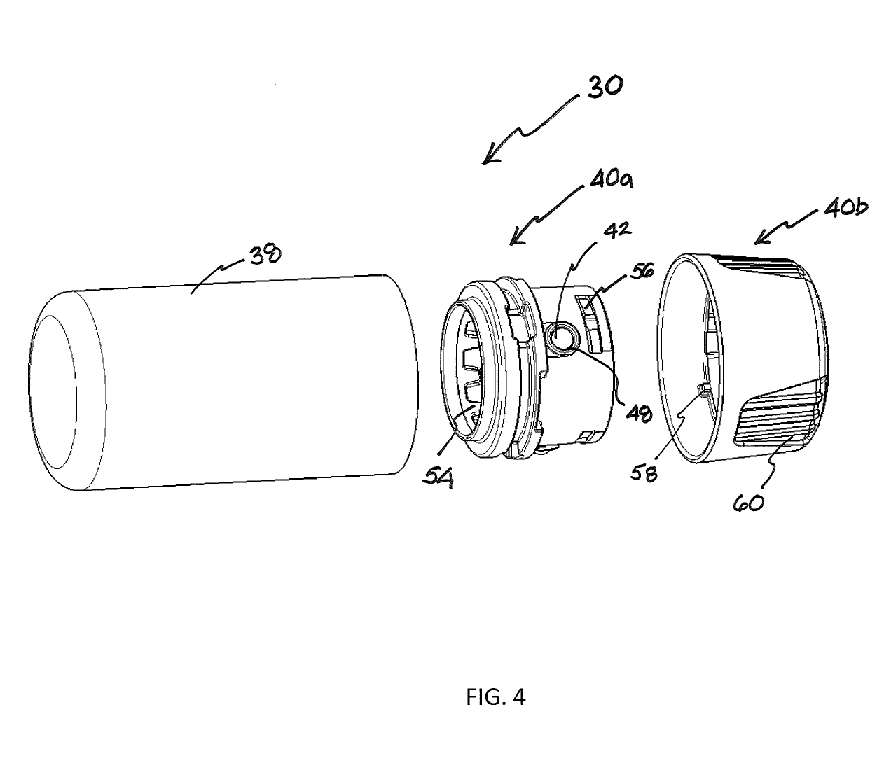

The locking member 42 is illustrated, for example, in FIGS. 4-6, as a ball. There can be any number of balls to serve as bearings to lock the collar assembly 40 and dust port 28 together. In an exemplary embodiment of the present invention, the collar assembly 40 has three balls. The balls can be formed from any material including but not limited to a metal, such as steel.

The outer collar 40b actuates locking members 42 by rotating in a first direction, either clockwise or counterclockwise, such that ramps 62, discussed below, protruding from the interior surface of the outer collar 40b engage push the locking members 42 radially into the locking member groove 50 on the dust port 28.

The inner collar 40a includes a plurality of inner collar castellations 54 along an interior surface at the distal end 46 of the collar assembly 40. In an embodiment, the inner collar castellations 54 form a raised surface. The plurality of castellations on the interior surface of the inner collar 40a mate or interlock with the raised surfaces formed by the plurality of dust port castellations 52 to join the collar assembly 40 and the dust port 28 together. The dust port 28 can have at least one castellation for mating with at least one castellation of the collar assembly 40 to provide resistance to relative rotation between the dust port and the collar assembly. The inner collar 40a can be removably fixed to the dust port 28 and an outer collar 40b can be rotatable with respect to the inner collar.

The inner collar 40a is thereby in a fixed rotational position with respect to the dust port 28, while the outer collar 40b is free to rotate. The rotary fixation of the inner collar 40a allows the user to rotate the outer collar 40b without disturbing the inner collar-dust port connection. In the embodiment illustrated in FIG. 3, for example, the number of castellations on the collar assembly 40 can be greater than the number of castellations on the dust port 28. Alternatively, the number of castellations on the collar assembly 40 can be less than the number of castellations on the dust port 28. As a result, the user can actuate the locking feature with one hand by rotating the outer collar 40b, without having to pre-align or look for alignment between the dust port and the collar assembly 40. Pre-alignment is an additional connection step wherein specific components must be aligned to effect a mating relationship. If the components are not aligned, adjustments must be made, such as tweaking the location of one component with respect to the other component to achieve the mating relationship before locking the components together.

In an exemplary embodiment of the present invention, because there are fewer castellations on the dust port 28 than on the collar assembly 40, when joining the dust port and collar assembly, any castellation on the dust port can achieve a mating relationship with the castellations on the collar assembly. As such, the user does not have to pre-align components of the collar assembly 40 with respect to the dust port 28 to begin locking the collar assembly to the dust port.

As shown in FIGS. 4 and 5, in addition to the plurality of locking apertures 48 radially spaced about the inner collar 40a, there are corresponding recess members 56 on an exterior surface thereof. The recess members 56 are located between the plurality of locking apertures 48 and the proximal end on an exterior surface of the inner collar 40a. The interior surface of the outer collar 40b includes snap tabs 58 at the proximal end 44 that removably snap into the recess members 56 on the exterior surface of the inner collar 40a.

As shown in FIGS. 3 and 4, the exterior surface of the outer collar 40b can have a gripping member 60 that provides a non-slip or resistive surface for the user to contact in rotating the outer collar.

The collar assembly 40 can be locked onto and unlocked from the dust port 28 by rotating the collar on the dust port thereby actuating or deactivating the locking member 42. The inner collar castellations 54 and the dust port castellations 52 on the exterior surface thereof provide an alignment between the collar assembly 40 and dust port and hold the connector mechanism in place so that the user need not pre-align the elements of the collar assembly and the dust port to establish the interface between the respective castellations prior to rotating the outer collar 40b to lock the collar assembly to the dust port.

The interior surface of the outer collar 40b includes ramps 62 corresponding to the number of locking members 42. The ramps have a rise portion at one end, which projects toward an interior of the outer collar, and a tapered portion at the opposite end which is substantially less projecting toward the interior surface of the outer collar. When the outer collar rotates in a first direction, the rise portion 64 of the ramps 62 apply a force to the locking members 42 and press the locking members into the locking member groove 50 of the dust port 28 to lock the collar assembly, specifically, through the inner collar 40a thereof, to the dust port. When the outer collar 40b rotates in a second direction opposite to the first direction, the force on the locking members 42 caused by the rise portion 64 of the ramps 62, is removed to unlock the collar assembly 40 from the dust port 28.

The connector mechanism 40 is locked to the dust port 28 by rotating the outer collar 40b with respect to the inner collar 40a and joined dust port 28 until the locking member is positioned within the locking member groove 50 on the elongated portion 36 of the dust port. Due to the force applied by the rise portion of the ramps 62, the plurality of locking members engages the locking member groove 50 in a friction fit.

As shown in the Figures, the number of castellations on the dust port exterior surface can be fewer than the number of castellations of the interior surface of the inner collar. This way, the dust port castellations and collar castellations do not require a specific alignment before being rotated and locked together. Therefore, the joining of the connector mechanism members and the subsequent locking of the dust bag to the dust port can be achieved in one fluid hand movement, which reduces connection time.

The castellations 52, 54 can be of any shape including, but not limited to: trapezoidal, square, triangular, rectangular, toothed, arcuate, or any shape capable of preventing rotational movement between the collar assembly 40 and the dust port 28.

As a result of the connector mechanism described herein, the dust bag or other accessory can be securely connected to the power tool and easily removed. The dust port can be coupled either to a passive dust collector, such as a bag or filter housing, or by a hose to an active system such as a vacuum cleaner. A hog ring can be provided to bias split segments of the dust port together.

While aspects of the present invention are described herein and illustrated in the accompanying drawings in the context of a sanding tool, those of ordinary skill in the art will appreciate that the invention, in its broadest aspects, has further applicability.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein, even if not specifically shown or described, so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims.

We claim:

1. A power tool, comprising:
a housing;
a dust port integrally formed with the housing;
a first plurality of castellations radially spaced about the dust port at a distal end, wherein a proximal end of the dust port further comprises an elongated portion adjacent to and axially spaced from the first plurality of castellations, the elongated portion having a continuous generally tubular shape;
a collar assembly having proximal and distal ends, the proximal end engaging the elongated portion of the dust port and the distal end comprising a second plurality of castellations radially spaced about an interior surface thereof for non-selectively engaging the first plurality of castellations to establish a mating interface between the collar assembly and the dust port; and
a plurality of locking members radially spaced about the collar assembly to establish a locking relationship between the collar assembly and the dust port.

2. The power tool of claim 1, wherein the collar assembly comprises an inner collar that is removably fixed to the dust port and an outer collar rotatable with respect to the inner collar.

3. The power tool of claim 2, wherein the first plurality of castellations are integrally formed on an exterior surface of the dust port and the second plurality of castellations are integrally formed on an interior surface of the inner collar.

4. The power tool of claim 3, wherein any of the second plurality of castellations on the inner collar achieve a mating interface with any of the first plurality of castellations on the dust port without pre-alignment.

5. The power tool of claim 3, wherein a number of castellations on the inner collar is greater than a number of castellations on the dust port.

6. The power tool of claim 2, wherein the inner collar comprises a plurality of apertures radially spaced thereabout and corresponding recess members on an exterior surface thereof, wherein the recess members are located between the plurality of apertures and the proximal end of the collar assembly.

7. The power tool of claim 6, wherein the plurality of locking members float within the plurality of apertures in the inner collar.

8. The power tool of claim 6, wherein an interior surface of the outer collar comprises snap tabs at the proximal end of the collar assembly that removably snap into the recess members on the exterior surface of the inner collar to retain the outer collar around the inner collar.

9. The power tool of claim 8, wherein the interior surface of the outer collar comprises ramps having a rise portion and a tapered portion, wherein when the outer collar rotates in a first direction, the rise portion of the ramps apply a force against the locking members to press the plurality of locking members into the locking member groove to lock the collar assembly to the dust port and, when the outer collar rotates in a second direction, opposite to the first direction, the force applied by the ramps is removed to unlock the collar assembly from the dust port.

10. The power tool of claim 1, wherein the elongated portion of the dust port comprises a radially configured locking member groove on an exterior surface thereof that receives the plurality of locking members.

11. The power tool of claim 10, wherein the plurality of locking members are received in the locking member groove in a friction fit.

12. The power tool of claim 1, wherein the plurality of locking members comprise metal balls.

13. The power tool of claim 1, wherein a dust bag for collecting debris from the power tool is fixed to the distal end of the collar assembly.

14. The power tool of claim 1, wherein the locking relationship creates a non-axially moveable connection between the collar assembly and the dust port.

15. A connector mechanism for a power tool comprising:
a collar assembly having an inner collar and an outer collar disposed around the inner collar; and
a plurality of locking members radially spaced about the inner collar between the inner collar and the outer collar and protruding into the interior of the inner collar,
wherein the inner collar includes a plurality of castellations radially spaced about an interior surface thereof for non-selectively engaging a portion of the power tool, and
wherein the plurality of locking members exerts a force on said portion of the power tool to establish a locking relationship between the collar assembly and the power tool.
